(19) United States
(12) Patent Application Publication
(10) Pub. No.: US 2016/0210632 A1
(43) Pub. Date: Jul. 21, 2016

(54) SECURED PAYMENT METHOD AND RELEVANT DEVICE AND SYSTEM

(71) Applicant: Tencent Technology (Shenzhen) Company Limited, Shenzhen (CN)

(72) Inventor: Li Jian Li, Shenzhen (CN)

(73) Assignee: Tencent Technology (Shenzhen) Company Limited

(21) Appl. No.: 14/982,906

(22) Filed: Dec. 29, 2015

Related U.S. Application Data
(63) Continuation of application No. PCT/CN2014/089400, filed on Oct. 24, 2014.

(30) Foreign Application Priority Data
Oct. 25, 2013 (CN) 201310513256.8

(51) Int. Cl. G06Q 20/40; G06Q 20/32

(52) U.S. Cl. CPC G06Q 20/4016; G06Q 20/3227

(57) ABSTRACT

The present disclosure discloses a secured payment method and relevant device and system. The method includes: sending, by a user terminal, order information to a payment platform server, receiving, by the payment platform server, the order information sent by the user terminal, and sending prompt information to the user terminal; receiving, by the user terminal, the prompt information sent by the payment platform server, and sending verification information to the payment platform server; and verifying whether the received fingerprint information and the received identifier of the user terminal match stored fingerprint information and a stored identifier of the user terminal that are stored during registration of the user terminal, and if yes, performing a payment operation according to the order information.

### CROSS-REFERENCE TO RELATED APPLICATIONS

This application is a continuation of International Application No. PCT/CN2014/089400, filed on Oct. 24, 2014, which claims priority to Chinese Patent Application No. 201310513256.8, filed on Oct. 25, 2013, which is incorporated by reference in its entirety.

### BACKGROUND OF THE TECHNOLOGY

The present disclosure relates to the field of Internet technologies, and more particularly to a secured payment method and relevant device and system.

With the rapid development of Internet technologies, it becomes a convenient and popular payment method to make the online payment by using a user terminal such as an intelligent mobile phone (such as an Android mobile phone and an iOS mobile phone), a tablet computer, a handheld computer, a mobile Internet device (MID), and a personal digital assistant (PDA).

In a practical application, when making the online payment by using a user terminal, a user usually needs to manually input a payment password on the user terminal to complete the online payment. It is found in practice that such a payment method requires a user to manually input a payment password. The manual input of a payment password may cause the leakage of the payment password, lowering the security of the payment.

### SUMMARY OF THE TECHNOLOGY

Examples of the present disclosure disclose a secured payment method and relevant device and system. By implementing those examples, a payment operation can be simplified, efficiency of online payment can be improved, and the security of payment can be enhanced.

In a first aspect, an example of the present disclosure discloses a secured payment method, which includes: sending, by a user terminal, order information to a payment platform server, wherein the order information comprises a payment account and a payment sum; receiving, by the payment platform server, the order information sent by the user terminal, and sending prompt information to the user terminal, wherein the prompt information is used for prompting an input of verification information; receiving, by the user terminal, the prompt information sent by the payment platform server, and sending verification information to the payment platform server, wherein the verification information comprises an identifier of the user terminal and fingerprint information input by the user terminal in response to the prompt information; and receiving, by the payment platform server, the verification information sent by the user terminal, verifying whether the received fingerprint information and the received identifier of the user terminal match stored fingerprint information and a stored identifier of the user terminal that are stored during registration of the user terminal, and if yes, performing a payment operation according to the order information.

In a second aspect, an example of the present disclosure discloses a secured payment method, which includes: receiving, by a payment platform server, order information sent by a user terminal, wherein the order information comprises a payment account and a payment sum; sending, by the payment platform server, prompt information to the user terminal, wherein the prompt information is used for prompting an input of verification information; receiving, by the payment platform server, verification information sent by the user terminal, wherein the verification information comprises an identifier of the user terminal and fingerprint information input by the user terminal in response to the prompt information; and verifying, by the payment platform server, whether the received fingerprint information and the received identifier of the user terminal included in the verification information match stored fingerprint information and a stored identifier of the user terminal that are stored during registration of the user terminal, and if yes, performing a payment operation according to the order information.

In a third, an example of the present disclosure discloses a payment platform server, which includes: a receiving unit, used to receive order information sent by a user terminal, wherein the order information comprises a payment account and a payment sum; a sending unit, used to send prompt information to the user terminal, wherein the prompt information is used for prompting an input of verification information; wherein the receiving unit is further used to receive the verification information sent by the user terminal, wherein the verification information comprises an identifier of the user terminal and fingerprint information input by the user terminal in response to the prompt information; a verification unit, used to verify whether the received fingerprint information and the received identifier of the user terminal included in the verification information match stored fingerprint information and a stored identifier of the user terminal that are stored during registration of the user terminal; and an operation unit, used to: when a verification result of the verification unit is yes, perform a payment operation according to the order information.

In a fourth aspect, an example of the present disclosure discloses a secured payment system, which includes a user terminal and a payment platform server, where: the user terminal is used to send order information to the payment platform server, wherein the order information comprises a payment account and a payment sum; the payment platform server is used to receive the order information sent by the user terminal, and send prompt information to the user terminal, wherein the prompt information is used for prompting an input of verification information; the user terminal is further used to receive the prompt information sent by the payment platform server, and send verification information to the payment platform server, wherein the verification information comprises an identifier of the user terminal and fingerprint information input by the user terminal in response to the prompt information; and the payment platform server is further used to receive the verification information sent by the user terminal, verify whether the received fingerprint information and the received identifier of the user terminal included in the verification information match stored fingerprint information and a stored identifier of the user terminal that are stored during registration of the user terminal, and if yes, perform a payment operation according to the order information.

In the examples of the present disclosure, after receiving order information sent by a user terminal, a payment platform server may send prompt information used for prompting input of verification information to the user terminal, so that the user terminal may send verification information to the payment platform server; the verification information includes an identifier of the user terminal and fingerprint information input by a user in response to the prompt information, so that when verifying that the fingerprint information and the identifier of the user terminal included in the verification information are the same as fingerprint information and an identifier of the user terminal that are recorded during registration of the user terminal respectively, the payment platform server may perform a payment operation according to the order information. Therefore, in the examples of the present disclosure, double security verification may be performed according to fingerprint information and an identifier of a user terminal, thereby enhancing security of payment; in addition, in the examples of the present disclosure, a complex operation resulting from that a user manually inputs a payment password is not needed, so that a payment operation is simplified, and efficiency of online payment is enhanced.

### BRIEF DESCRIPTION OF THE DRAWINGS

To describe the technical solutions in the examples of the present disclosure more clearly, the following briefly introduces the accompanying drawings required for describing the examples. Apparently, the accompanying drawings in the following description show some examples of the present disclosure, and persons of ordinary skill in the art may still derive other drawings from these accompanying drawings without creative efforts.

The system and/or method may be better understood with reference to the following drawings and description. Non-limiting and non-exhaustive descriptions are described with reference to the following drawings. The components in the FIG.s are not necessarily to scale, emphasis instead being placed upon illustrating principles. In the FIG.s, like referenced numerals may refer to like parts throughout the different FIG.s unless otherwise specified.

FIG. 1 is a flow chart of a secured payment method disclosed in an example of the present disclosure;

FIG. 2 is a schematic diagram of an interface in which a user terminal prompts a user to input fingerprint information in a fingerprint input area disclosed in an example of the present disclosure;

FIG. 3 is a schematic diagram of an interface for displaying an order information confirmation request of a user terminal disclosed in an example of the present disclosure;

FIG. 4 is a flow chart of another secured payment method disclosed in an example of the present disclosure;

FIG. 5 is a flow chart of another secured payment method disclosed in an example of the present disclosure;

FIG. 6 is a flow chart of another secured payment method disclosed in an example of the present disclosure;

FIG. 7 is a flow chart of another secured payment method disclosed in an example of the present disclosure;

FIG. 8 is a structural diagram of a user terminal disclosed in an example of the present disclosure;

FIG. 9 is a structural diagram of another user terminal disclosed in an example of the present disclosure;

FIG. 10 is a structural diagram of a payment platform server disclosed in an example of the present disclosure;

FIG. 11 is a structural diagram of another payment platform server disclosed in an example of the present disclosure; and

FIG. 12 is a structural diagram of a secured payment system disclosed in an example of the present disclosure.

### DETAILED DESCRIPTION THE TECHNOLOGY

The principles described herein may be embodied in many different forms. Not all of the depicted components may be required, however, and some implementations may include additional components. Variations in the arrangement and type of the components may be made without departing from the spirit or scope of the claims as set forth herein. Additional, different or fewer components may be provided.

Reference throughout this specification to “one example,” “an example,” “examples,” “one embodiment,” “an embodiment,” “example embodiment,” or the like in the singular or plural means that one or more particular features, structures, or characteristics described in connection with an embodiment or an example is included in at least one embodiment or one example of the present disclosure. Thus, the appearances of the phrases “in one embodiment,” “in an embodiment,” “in an example embodiment,” “in one example,” “in an example,” or the like in the singular or plural in various places throughout this specification are not necessarily all referring to the same embodiment. Furthermore, the particular features, structures, or characteristics may be combined in any suitable manner in one or more embodiments or examples.

The terminology used in the description of the invention herein is for the purpose of describing particular examples only and is not intended to be limiting of the invention. As used in the description of the invention and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the terms “module,” “unit” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The exemplary environment may include a server, a terminal device, and a communication network. The server and the terminal device may be coupled through the communication network for information exchange, such as sending/receiving identification information, sending/receiving data files such as splash screen images, etc. Although only one terminal device and one server are shown in the environment, any number of terminals or servers may be included, and other devices may also be included.

The communication network may include any appropriate type of communication network for providing network connections to the server and terminal device or among multiple servers or terminal devices. For example, communication network may include the Internet or other types of computer networks or telecommunication networks, either wired or wireless. In a certain embodiment, the disclosed methods and apparatus may be implemented, for example, in a wireless network that includes at least one terminal device.

In some cases, the terminal device or the device may refer to any appropriate user terminal with certain computing capabilities, such as a personal computer (PC), a work station computer, a server computer, a hand-held computing device (tablet), a smart phone or mobile phone, or any other user-side computing device. In various embodiments, the terminal device may include a network access device. The terminal device may be stationary or mobile.

A server, as used herein, may refer to one or more server computers configured to provide certain server functionalities, such as database management and search engines. A server may also include one or more processors to execute computer programs in parallel.

It should be noticed that, the embodiments/examples and the features in the embodiments/examples may be combined with each other in a no conflict condition. This invention will become apparent from the following detailed description when taken in conjunction with the accompanying drawings.

It should be noticed that, the steps illustrated in the flowchart of the drawings may be performed in a set of computer device with executable program codes. And the order of the steps may be different from that in the drawings under some status, although a logic order is shown in the flowchart.

The purpose, technical proposal and advantages in the examples of the present disclosure will become more clear and complete from the following detailed description when taken in conjunction with the appended drawings. Apparently, the examples described thereinafter are merely a part of examples of the present disclosure, not all examples. Persons skilled in the art can obtain all other examples without creative works, based on these examples, which pertains to the protection scope of the present disclosure.

To make the objectives, technical solutions, and advantages of the examples of the present disclosure more clearly, the following clearly and completely describes the technical solutions in the examples of the present disclosure with reference to the accompanying drawings in the examples of the present disclosure. Apparently, the described examples are merely a part rather than all of the examples of the present disclosure. All other examples obtained by persons of ordinary skill in the art based on the examples of the present disclosure without creative efforts shall fall within the protection scope of the present disclosure.

Examples of the present disclosure disclose a secured payment method and relevant device and system, so that a payment operation can be simplified, efficiency of online payment is improved, and security of payment is enhanced. Detailed illustration is given below respectively.

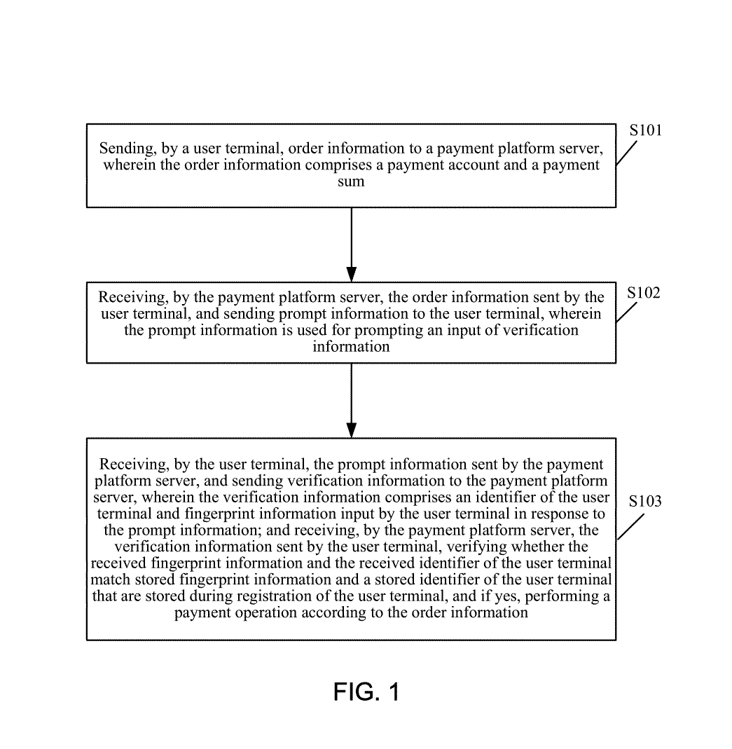

Referring to FIG. 1, FIG. 1 is a flow chart of a secured payment method disclosed in an example of the present disclosure. The secured payment method described in FIG. 1 is mainly described from the side of a user terminal. As shown in FIG. 1, the secured payment method may include the following steps.

S101. Sending, by a user terminal, order information to a payment platform server, wherein the order information comprises a payment account and a payment sum.

In an example of the present disclosure, the payment account refers to a payer account. The order information may further include an order number.

In an example of the present disclosure, the user terminal includes a user terminal such as an intelligent mobile phone (such as an Android mobile phone and an iOS mobile phone), a tablet computer, a handheld computer, a MID, and a PDA.

S102. Receiving, by the payment platform server, the order information sent by the user terminal, and sending prompt information to the user terminal, wherein the prompt information is used for prompting an input of verification information.

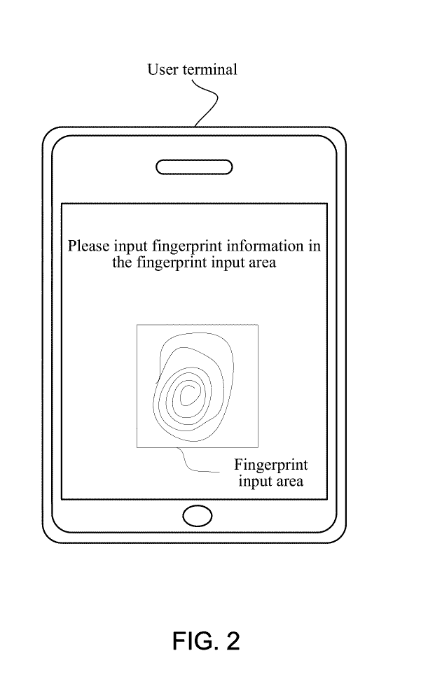

In an example of the present disclosure, after receiving the prompt information sent by the payment platform server, the user terminal may prompt, through a display, a user to input fingerprint information. In an example, as shown in FIG. 2, the user terminal may prompt a user to input fingerprint information in a fingerprint input area.

S103. Receiving, by the user terminal, the prompt information sent by the payment platform server, and sending verification information to the payment platform server, wherein the verification information comprises an identifier of the user terminal and fingerprint information input by the user terminal in response to the prompt information; and receiving, by the payment platform server, the verification information sent by the user terminal, verifying whether the received fingerprint information and the received identifier of the user terminal match stored fingerprint information and a stored identifier of the user terminal that are stored during registration of the user terminal, and if yes, performing a payment operation according to the order information.

As an optional implementation manner, in the method shown in FIG. 1, before executing Step S101, the user terminal may first execute the following steps:

11). Sending, by the user terminal, a registration request to the payment platform server, wherein the registration request comprises the identifier of the user terminal.

In an example of the present disclosure, the identifier of the user terminal may include an International Mobile Equipment Identification Number (IMEI) of the user terminal, or include other system information, which can represent identity information, of the user terminal.

12). Receiving, by the user terminal, the notification message sent by the payment platform server.

In an example of the present disclosure, after receiving the notification message sent by the payment platform server, the user terminal may, as shown in FIG. 2, prompt a user to input fingerprint information in a fingerprint input area.

13). Sending, to the payment platform server, the fingerprint information input by the user terminal in response to the notification message.

14). Receiving, by the user terminal, the registration complete response sent by the payment platform server.

The registration of the user terminal on the payment platform server may be accomplished through Step 11) to Step 14), and it is implemented in a registration process that fingerprint information and an identifier of the user terminal are recorded and stored on the payment platform server for subsequent double security verification.

As an optional implementation manner, in the method shown in FIG. 1, after sending the verification information to the payment platform server, the user terminal may further execute the following steps:

21). Receiving, from the payment platform server, an order information confirmation request to the user terminal, wherein the order information confirmation request comprises the payment account and the payment sum.

22). Sending, to the payment platform server, a confirmation response to the order information confirmation request input by the user terminal.

Security of payment may be enhanced through Step 21) and Step 22).

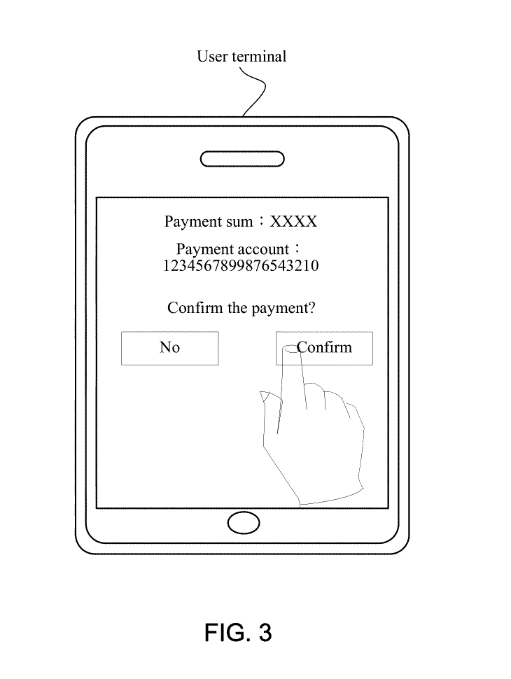

In an example of the present disclosure, as shown in FIG. 3, the user terminal may output an order information confirmation request sent by the payment platform server, where the order information confirmation request may include a payment sum “XXXX” and a payment account “1234567899876543210”. Correspondingly, the user may click a “Confirm” option in the user interface shown in FIG. 3, so as to input, in the user terminal. And the, a confirmation response to the order information confirmation request, and correspondingly the user terminal may send, to a transaction platform server, the confirmation response to the order information confirmation request.

As an optional implementation manner, in the method shown in FIG. 1, the user terminal sends order information to a payment platform server in a specific manner as follows:

The user terminal sends order information to the transaction platform server, and the transaction platform server sends the order information to the payment platform server. Such a manner allows the user to perform secured payment in a process of placing an order.

In an example of the present disclosure, the user terminal may also directly send order information to the payment platform server, and such a manner allows secured payment in a process of point-to-point payment (for example, swipe payment with a mobile phone).

Therefore, for the method described in FIG. 1, double security verification may be performed according to fingerprint information and an identifier of a user terminal, and a payment operation is allowed after the double security verification, thereby enhancing security of payment; in addition, for the method described in FIG. 1, a complex operation resulting from that a user manually inputs a payment password is not needed, so that a payment operation is simplified, and efficiency of online payment is enhanced.

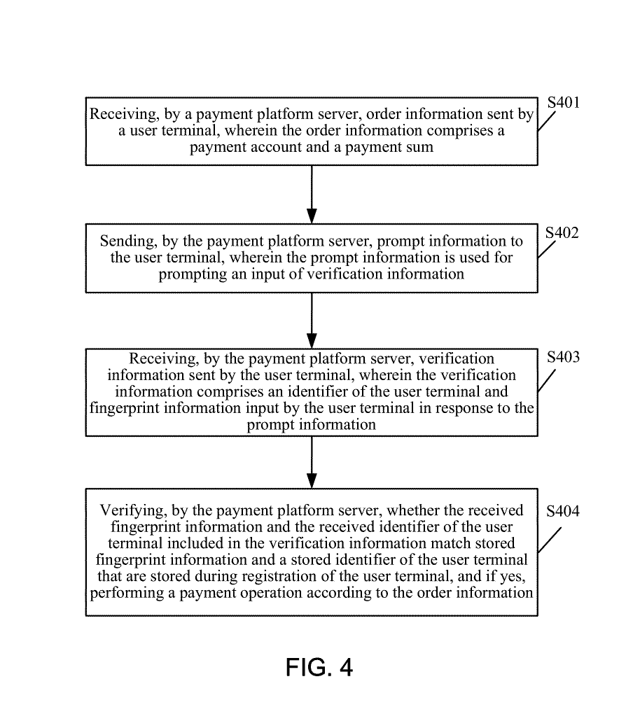

Referring to FIG. 4, FIG. 4 is a flow chart of another secured payment method disclosed in an example of the present disclosure. The secured payment method described in FIG. 4 is mainly described from the side of a payment platform server. As shown in FIG. 4, the secured payment method may include the following steps.

S401. Receiving, by a payment platform server, order information sent by a user terminal, wherein the order information comprises a payment account and a payment sum.

S402. Sending, by the payment platform server, prompt information to the user terminal, wherein the prompt information is used for prompting an input of verification information.

S403. Receiving, by the payment platform server, verification information sent by the user terminal, wherein the verification information comprises an identifier of the user terminal and fingerprint information input by the user terminal in response to the prompt information.

S404. Verifying, by the payment platform server, whether the received fingerprint information and the received identifier of the user terminal included in the verification information match stored fingerprint information and a stored identifier of the user terminal that are stored during registration of the user terminal, and if yes, performing a payment operation according to the order information.

In an example of the present disclosure, the payment platform server performs a payment operation according to the order information: the payment platform server may deduct the payment sum included in the order information from the payment account included in the order information, and pays the payment sum to a corresponding recipient account.

As an optional implementation manner, in the method described in FIG. 4, before executing Step S401, the payment platform server may further execute the following steps:

31). Receiving, by the payment platform server, a registration request sent by the user terminal, wherein the registration request comprises the identifier of the user terminal.

32). Sending, by the payment platform server, a notification message to the user terminal in response to the registration request, wherein the notification message is used for prompting the input of the fingerprint information.

33). Receiving, by the payment platform server, the fingerprint information sent by the user terminal, and storing the fingerprint information sent by the user terminal and the identifier of the user terminal included in the registration request.

34). Sending, by the payment platform server, a registration complete response to the user terminal.

The registration of the user terminal on the payment platform server may be accomplished through Step 31) to Step 34), and it is implemented in a registration process that fingerprint information and an identifier of the user terminal are recorded and stored on a payment platform server for subsequent double security verification.

As an optional implementation manner, in the method described in FIG. 4, after verifying the fingerprint information and the identifier of the user terminal included in the verification information are the same as the fingerprint information and the identifier of the user terminal that are recorded during registration of the user terminal respectively, and before performing a payment operation according to the order information, the payment platform server may further execute the following steps:

41). Sending, by the payment platform server, an order information confirmation request to the user terminal, wherein the order information confirmation request comprises the payment account and the payment sum.

42). After receiving a confirmation response to the order information confirmation request sent by the user terminal, performing, by the payment platform server, the payment operation according to the order information.

Security of payment may be enhanced through Step 41) and Step 42).

As an optional implementation manner, in the method described in FIG. 4, the payment platform server may receive the order information sent by the user terminal in a specific manner as follows:

Receiving, by the payment platform server, the order information, sent through a transaction platform server, by the user terminal.

Furthermore, the method described in FIG. 4 may further include the following steps:

51). Receiving, by the payment platform server, a discount rate that is sent by the transaction platform server and corresponds to a sum range where a historical payment sum of the user terminal belongs.

52). Performing, by the payment platform server, a payment discount operation according to the order information and the discount rate.

A payment discount operation may be implemented through Step 51) and Step 52), so as to stimulate transaction and consumption.

Therefore, for the method described in FIG. 2, double security verification may be performed according to fingerprint information and an identifier of a user terminal, and a payment operation is allowed after the double security verification, thereby enhancing security of payment. In addition, for the method described in FIG. 2, a complex operation resulting from that a user manually inputs a payment password is not needed. As such, a payment operation is simplified, and efficiency of online payment is enhanced.

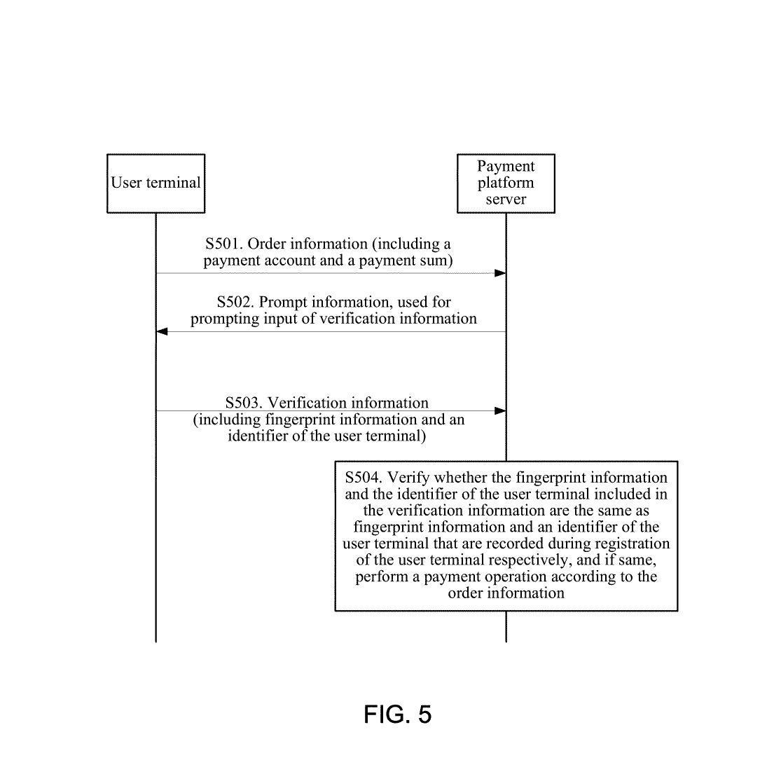

Referring to FIG. 5, FIG. 5 is a flow chart of another secured payment method disclosed in an example of the present disclosure. The secured payment method described in FIG. 5 is mainly described from both sides of a user terminal and a payment platform server. As shown in FIG. 5, the secured payment method may include the following steps.

S501. A user terminal sends order information to a payment platform server, where the order information includes a payment account and a payment sum.

S502. The payment platform server receives the order information sent by the user terminal, and sends prompt information to the user terminal, where the prompt information is used for prompting input of verification information.

S503. The user terminal receives the prompt information sent by the payment platform server, and sends verification information to the payment platform server, where the verification information includes an identifier of the user terminal and fingerprint information input by a user in response to the prompt information.

S504. The payment platform server receives the verification information sent by the user terminal, and verifies whether the fingerprint information and the identifier of the user terminal included in the verification information are the same as fingerprint information and an identifier of the user terminal that are recorded during registration of the user terminal respectively, and if same, performs a payment operation according to the order information.

Therefore, for the method described in FIG. 5, double security verification may be performed according to fingerprint information and an identifier of a user terminal, and a payment operation is allowed after the double security verification, thereby enhancing security of payment. In addition, for the method described in FIG. 5, a complex operation resulting from that a user manually inputs a payment password is not needed, so that a payment operation is simplified, and efficiency of online payment is enhanced.

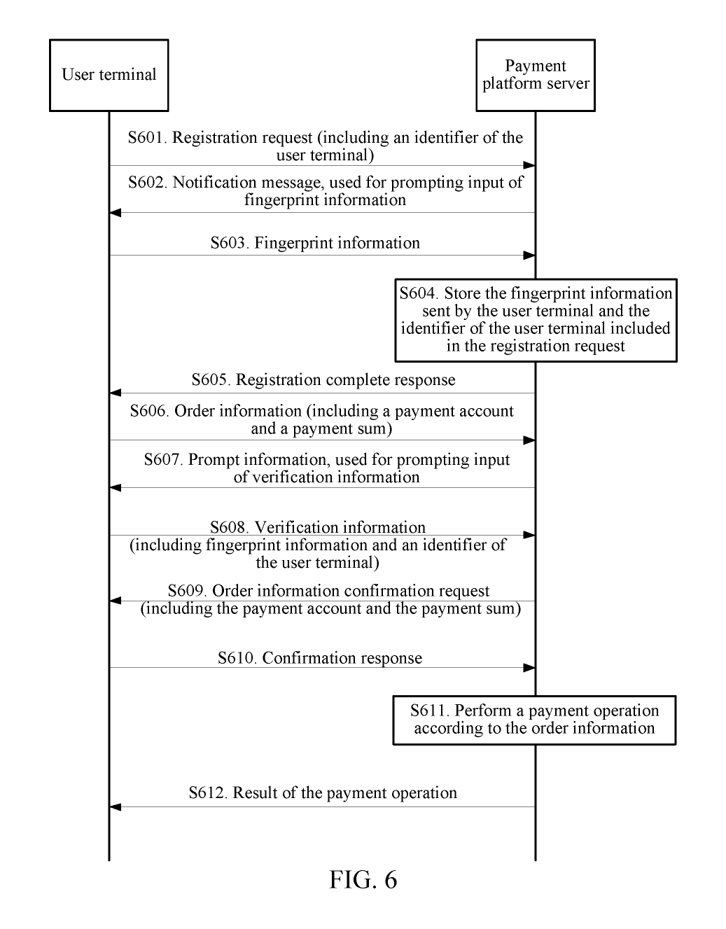

Referring to FIG. 6, FIG. 6 is a flow chart of another secured payment method disclosed in an example of the present disclosure. The secured payment method described in FIG. 6 is mainly described from both sides of a user terminal and a payment platform server. As shown in FIG. 6, the secured payment method may include the following steps.

S601. A user terminal sends a registration request to a payment platform server, where the registration request includes an identifier of the user terminal.

S602. The payment platform server sends a notification message to the user terminal in response to the registration request, where the notification message is used for prompting input of fingerprint information.

S603. The user terminal receives the notification message sent by the payment platform server, and sends, to the payment platform server, fingerprint information input by the user in response to the notification message.

S604. The payment platform server stores the fingerprint information sent by the user terminal and the identifier of the user terminal included in the registration request.

S605. The payment platform server sends a registration complete response to the user terminal.

S606. The user terminal sends order information to the payment platform server, where the order information includes a payment account and a payment sum.

S607. The payment platform server receives the order information sent by the user terminal, and sends prompt information to the user terminal, where the prompt information is used for prompting input of verification information.

S608. The user terminal receives the prompt information sent by the payment platform server, and sends verification information to the payment platform server, where the verification information includes an identifier of the user terminal and fingerprint information input by a user in response to the prompt information.

S609. The payment platform server receives the verification information sent by the user terminal, and verifies whether the fingerprint information and the identifier of the user terminal included in the verification information are the same as the fingerprint information and the identifier of the user terminal that are recorded during registration of the user terminal respectively, and if same, sends an order information confirmation request to the user terminal, where the order information confirmation request includes the payment account and the payment sum.

S610. The user terminal receives the order information confirmation request sent by the payment platform server, and sends, to the payment platform server, a confirmation response to the order information confirmation request and input by the user.

S611. After receiving the confirmation response to the order information confirmation request and sent by the user terminal, the payment platform server performs a payment operation according to the order information.

S612. The payment platform server sends a result of the payment operation to the user terminal.

Therefore, for the method described in FIG. 6, double security verification may be performed according to fingerprint information and an identifier of a user terminal, and a payment operation is allowed after the double security verification, thereby enhancing security of payment. In addition, for the method described in FIG. 6, a complex operation resulting from that a user manually inputs a payment password is not needed, so that a payment operation is simplified, and efficiency of online payment is enhanced.

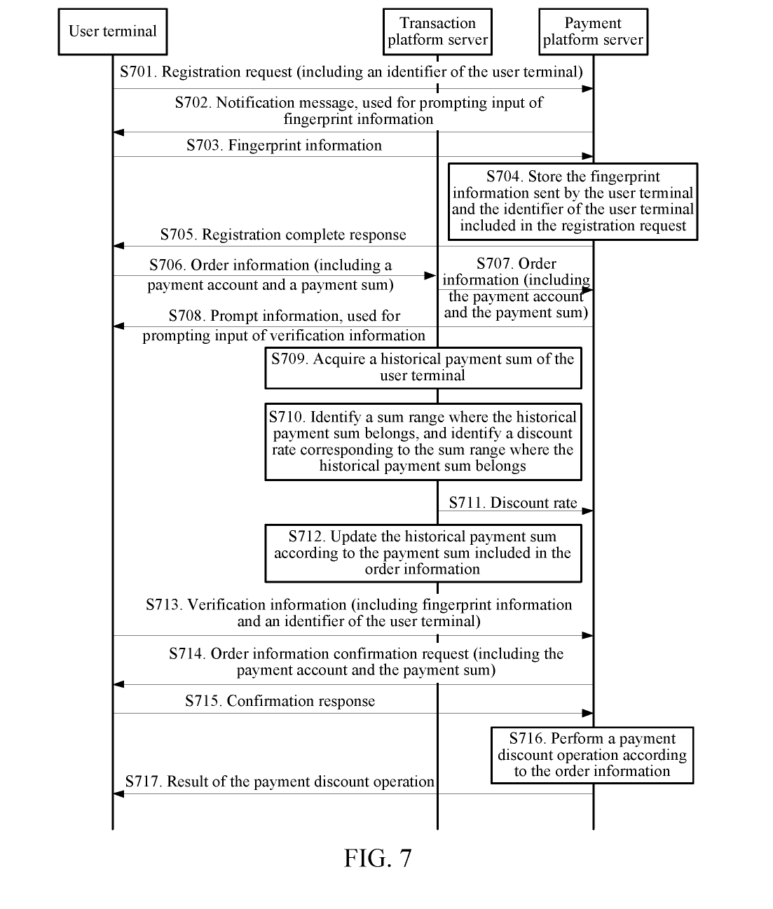

Referring to FIG. 7, FIG. 7 is a flow chart of another secured payment method disclosed in an example of the present disclosure. The secured payment method described in FIG. 7 is mainly described from three sides of a user terminal, a transaction platform server, and a payment platform server. As shown in FIG. 7, the secured payment method may include the following steps.

S701. A user terminal sends a registration request to a payment platform server, where the registration request includes an identifier of the user terminal.

S702. The payment platform server sends a notification message to the user terminal in response to the registration request, where the notification message is used for prompting input of fingerprint information.

S703. The user terminal receives the notification message sent by the payment platform server, and sends, to the payment platform server, fingerprint information input by a user in response to the notification message.

S704. The payment platform server stores the fingerprint information sent by the user terminal and the identifier of the user terminal included in the registration request.

S705. The payment platform server sends a registration complete response to the user terminal.

S706. The user terminal sends order information to a transaction platform server, where the order information includes a payment account and a payment sum.

S707. The transaction platform server sends the order information to the payment platform server.

S708. The payment platform server receives the order information sent by the transaction platform server, and sends prompt information to the user terminal, where the prompt information is used for prompting input of verification information.

S709. The transaction platform server acquires a historical payment sum of the user terminal.

S710. The transaction platform server identifies a sum range where the historical payment sum belongs, and identifies a discount rate corresponding to the sum range where the historical payment sum belongs.

S711. The transaction platform server sends the discount rate to the payment platform server.

S712. The transaction platform server updates the historical payment sum according to the payment sum included in the order information.

In an example of the present disclosure, the transaction platform server may add the payment sum included in the order information and the historical payment sum, and use the accumulated value as a new historical payment sum.

S713. The user terminal receives the prompt information sent by the payment platform server, and sends verification information to the payment platform server, where the verification information includes an identifier of the user terminal and fingerprint information input by the user in response to the prompt information.

S714. The payment platform server receives the verification information sent by the user terminal, verifies whether the fingerprint information and the identifier of the user terminal included in the verification information are the same as the fingerprint information and the identifier of the user terminal that are recorded during registration of the user terminal respectively, and if same, sends an order information confirmation request to the user terminal, where the order information confirmation request includes the payment account and the payment sum.

S715. The user terminal receives the order information confirmation request sent by the payment platform server, and sends, to the payment platform server, a confirmation response to the order information confirmation request and input by the user.

S716. After receiving the confirmation response to the order information confirmation request and sent by the user terminal, the payment platform server performs a payment discount operation according to the order information and the discount rate.

S717. The payment platform server sends a result of the payment discount operation to the user terminal.

In an example of the present disclosure, Step S709 to Step S712 in the foregoing only need to be performed after Step S707 and before Step S716, and a specific performing sequence is not limited in the example of the present disclosure.

Therefore, for the method described in FIG. 7, double security verification may be performed according to fingerprint information and an identifier of a user terminal, and a payment operation is allowed after the double security verification, thereby enhancing security of payment. In addition, for the method described in FIG. 7, a complex operation resulting from that a user manually inputs a payment password is not needed, so that a payment operation is simplified, and efficiency of online payment is enhanced.

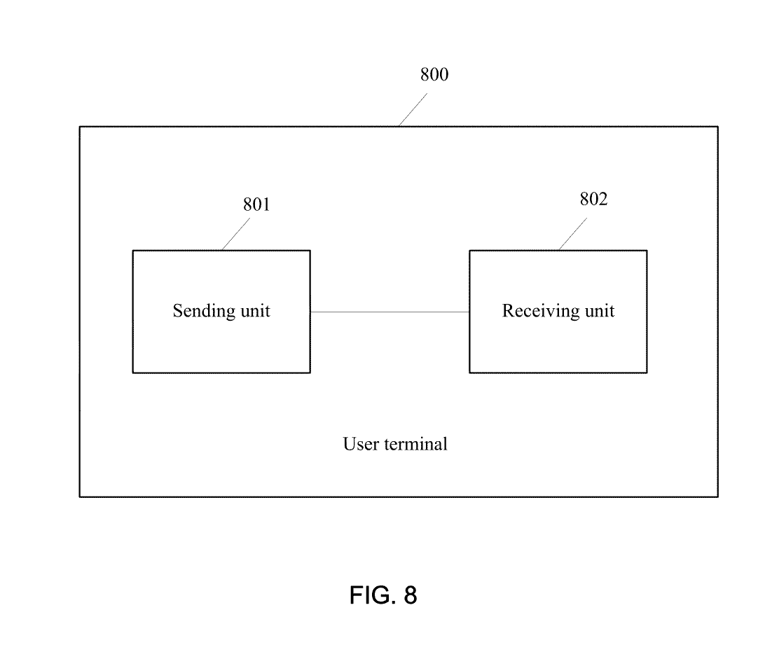

Referring to FIG. 8, FIG. 8 is a structural diagram of a user terminal disclosed in an example of the present disclosure. As shown in FIG. 8, a user terminal 800 may include: a sending unit 801, used to send order information to a payment platform server, where the order information includes a payment account and a payment sum; and a receiving unit 802, used to receive prompt information sent by the payment platform server, where the prompt information is used for prompting input of verification information; where the sending unit 801 is further used to send verification information to the payment platform server, so that when verifying that an identifier of the user terminal and fingerprint information input by a user in response to the prompt information included in the verification information are the same as an identifier of the user terminal and fingerprint information that are recorded during registration of the user terminal respectively, the payment platform server performs a payment operation according to the order information.

In an example, the sending unit 801 is further used to: before sending order information to a payment platform server, send a registration request to the payment platform server, where the registration request includes an identifier of the user terminal; correspondingly, the receiving unit 802 is further used to receive a notification message sent by the payment platform server, where the notification message is used for prompting input of fingerprint information; correspondingly, the sending unit 801 is further used to send, to the payment platform server, fingerprint information input by the user in response to the notification message; and correspondingly, the receiving unit 802 is further used to receive a registration complete response sent by the payment platform server.

In an example of the present disclosure, the receiving unit 802 is further used to: after the sending unit 801 sends the verification information to the payment platform server, receive an order information confirmation request sent by the payment platform server, where the order information confirmation request includes the payment account and the payment sum; and correspondingly, the sending unit 801 is further used to send, to the payment platform server, a confirmation response to the order information confirmation request and input by the user.

Therefore, by means of the user terminal described in the example in FIG. 8, double security verification may be implemented according to fingerprint information and an identifier of the user terminal, and a payment operation is allowed after the double security verification, thereby enhancing security of payment. In addition, by means of the user terminal described in FIG. 8, a complex operation resulting from that a user manually inputs a payment password is not needed, so that a payment operation is simplified, and efficiency of online payment is enhanced.

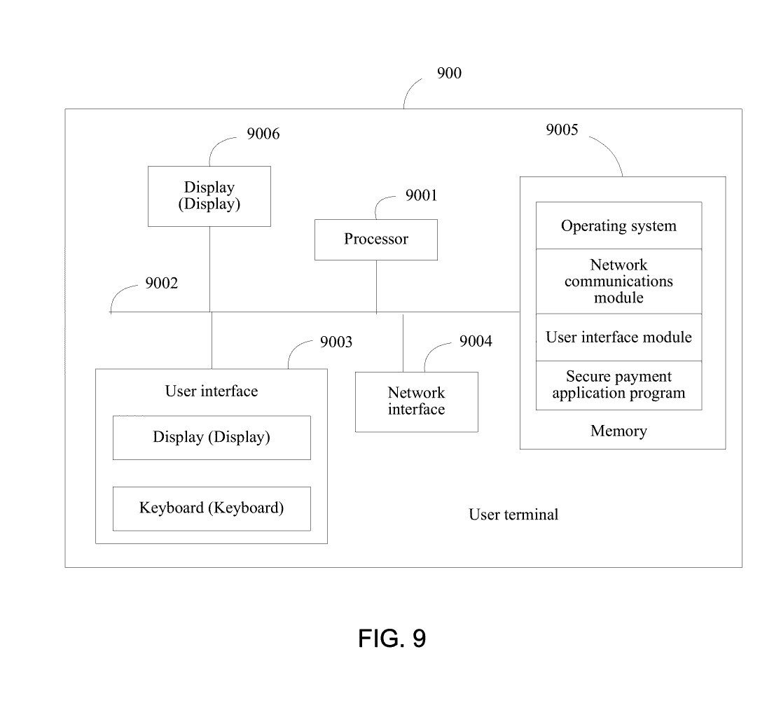

Referring to FIG. 9, FIG. 9 is a structural diagram of another user terminal disclosed in an example of the present disclosure. As shown in FIG. 9, a user terminal 900 may include: at least one processor 9001, for example, a central processing unit (CPU), at least one network interface 9004, a user interface 9003, a memory 9005, at least one communication bus 9002, and a display 9006. The communication bus 9002 is used to implement connection and communication among these components. The user interface 9003 may include a display and a keyboard; optionally, the user interface 9003 may further include a standard wired interface or wireless interface. The network interface 9004 optionally may include a standard wired interface, a wireless interface (for example, a Wireless Fidelity (WI-FI) interface). The memory 9005 may be a high-speed random access memory (RAM), or may also be a non-volatile memory, for example, at least one disk memory. The memory 9005 optionally may further be at least one storage apparatus located far away from the foregoing processor 9001. As shown in FIG. 9, the memory 9005 serving as a computer storage medium may include an operating system, a network communications module, a user interface module, and a secured payment application program.

In the user terminal 9000 shown in FIG. 9, the network interface 9004 is mainly used to connect a transaction platform server and a payment platform server and perform data communication with the transaction platform server and the payment platform server. The processor 9001 may be used to invoke the secured payment application program stored in the memory 9005 to execute the following operations:

Sending order information to the payment platform server through the network interface 9004, where the order information includes a payment account and a payment sum; receiving, through the network interface 9004, prompt information sent by the payment platform server, where the prompt information is used for prompting input of verification information; and sending verification information to the payment platform server through the network interface 9004.

When verifying that an identifier of the user terminal and fingerprint information input (for example, input through the display 9006) by a user in response to the prompt information included in the verification information are the same as an identifier of the user terminal and fingerprint information that are recorded during registration of the user terminal respectively, the payment platform server performs a payment operation according to the order information.

In an example, the processor 9001 invokes the secured payment application program stored in the memory 9005 to further execute the following operations: before sending order information to a payment platform server through the network interface 9004, sending a registration request to the payment platform server through the network interface 9004, where the registration request includes an identifier of the user terminal; receiving, through the network interface 9004, a notification message sent by the payment platform server, where the notification message is used for prompting input of fingerprint information; sending, through the network interface 9004 to the payment platform server, fingerprint information input by the user in response to the notification message; and receiving, through the network interface 9004, a registration complete response sent by the payment platform server.

In an example, the processor 9001 invokes the secured payment application program stored in the memory 9005 to further execute the following operations: after sending the verification information to the payment platform server through the network interface 9004, receiving, through the network interface 9004, an order information confirmation request sent by the payment platform server, where the order information confirmation request includes the payment account and the payment sum; and sending, through the network interface 9004 to the payment platform server, a confirmation response to the order information confirmation request and input by the user.

In an example of the present disclosure, that the processor 9001 sends order information to a payment platform server through the network interface 9004 includes: sending, by the processor 9001 through the network interface 9004, order information to a transaction platform server, and sending, by the transaction platform server, the order information to the payment platform server.

Therefore, by means of the user terminal described in the example in FIG. 9, double security verification may be implemented according to fingerprint information and an identifier of the user terminal, and a payment operation is allowed after the double security verification, thereby enhancing security of payment. In addition, by means of the user terminal described in FIG. 9, a complex operation resulting from that a user manually inputs a payment password is not needed, so that a payment operation is simplified, and efficiency of online payment is enhanced.

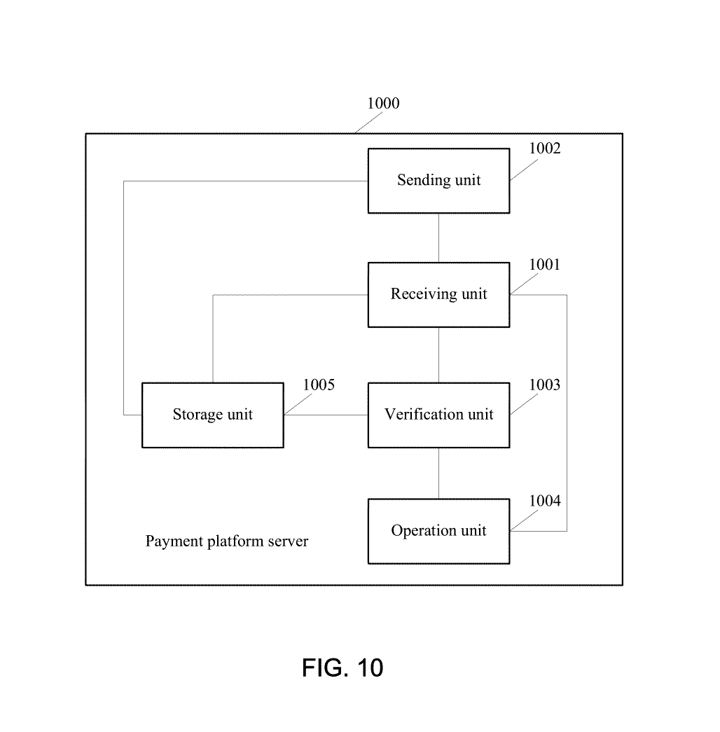

Referring to FIG. 10, FIG. 10 is a structural diagram of a payment platform server disclosed in an example of the present disclosure. As shown in FIG. 10, a payment platform server 1000 includes: a receiving unit 1001, used to receive order information sent by a user terminal, where the order information includes a payment account and a payment sum; and a sending unit 1002, used to send prompt information to the user terminal, where the prompt information is used for prompting input of verification information; where the receiving unit 1001 is further used to receive verification information sent by the user terminal, where the verification information includes an identifier of the user terminal and fingerprint information input by a user in response to the prompt information; a verification unit 1003, used to verify whether the fingerprint information and the identifier of the user terminal included in the verification information are the same as fingerprint information and an identifier of the user terminal that are recorded during registration of the user terminal respectively; and an operation unit 1004, used to: when a verification result of the verification unit 1003 is same, perform a payment operation according to the order information.

In an example, the receiving unit 1001 is further used to: before receiving order information sent by a user terminal, receive a registration request sent by the user terminal, where the registration request includes an identifier of the user terminal; correspondingly, the sending unit 1002 is further used to send a notification message to the user terminal in response to the registration request received by the receiving unit 1001, where the notification message is used for prompting input of fingerprint information;

correspondingly, the receiving unit 1001 is further used to receive fingerprint information sent by the user terminal; correspondingly, the payment platform server 1000 further includes: a storage unit 1005, used to store the fingerprint information sent by the user terminal and the identifier of the user terminal included in the registration request; and correspondingly, the sending unit 1002 is further used to send a registration complete response to the user terminal.

In an example of the present disclosure, the verification unit 1003 is specifically used to verify whether the fingerprint information and the identifier of the user terminal included in the verification information are the same as the fingerprint information and the identifier of the user terminal that are recorded during registration of the user terminal and stored in the storage unit 1005 respectively.

In an example, the sending unit 1002 is further used to: after the verification unit 1003 verifies that the fingerprint information and the identifier of the user terminal included in the verification information are the same as the fingerprint information and the identifier of the user terminal that are recorded during registration of the user terminal respectively, send an order information confirmation request to the user terminal, where the order information confirmation request includes the payment account and the payment sum; and correspondingly, the receiving unit 1001 is further used to: after receiving a confirmation response to the order information confirmation request and sent by the user terminal, trigger the operation unit 1004 to execute the step of performing a payment operation according to the order information.

In an example, the receiving unit 1001 receives the order information sent by the user terminal in a specific manner as follows: the receiving unit 1001 is used to receive order information sent, through a transaction platform server, by a user terminal; and furthermore, the receiving unit 1001 is further used to receive a discount rate that is sent by the transaction platform server and corresponds to a sum range where a historical payment sum of the user terminal belongs; and correspondingly, the operation unit 1004 is further used to perform a payment discount operation according to the order information and the discount rate.

Therefore, by means of the payment platform server described in the example in FIG. 10, double security verification may be implemented according to fingerprint information and an identifier of a user terminal, and a payment operation is allowed after the double security verification, thereby enhancing security of payment. In addition, by means of the payment platform server described in FIG. 10, a complex operation resulting from that a user manually inputs a payment password may not be needed for the user terminal, so that a payment operation is simplified, and efficiency of online payment is enhanced.

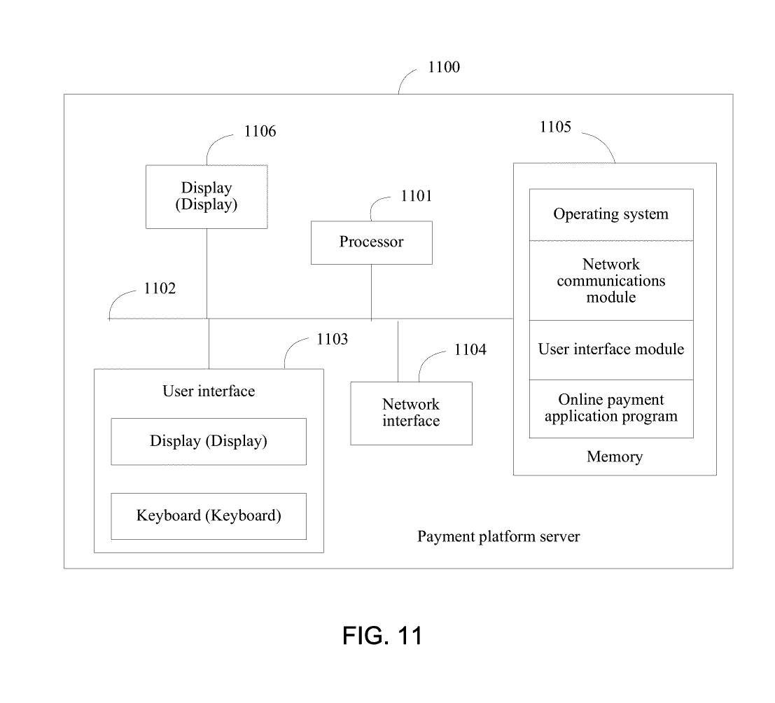

Referring to FIG. 11, FIG. 11 is a structural diagram of another payment platform server disclosed in an example of the present disclosure. As shown in FIG. 11, a payment platform server 1100 includes: at least one processor 1101, for example, a CPU, at least one network interface 1104, a user interface 1103, a memory 1105, at least one communication bus 1102.

The communication bus 1102 is used to implement connection and communication among these components. The user interface 1103 may include a display and a keyboard; the optional user interface 1103 may further include a standard wired interface or wireless interface. The network interface 1104 optionally may include a standard wired interface or wireless interface (for example, a WI-FI interface). The memory 1105 may be a high-speed RAM, or may also be a non-volatile memory, for example, at least one disk memory. The memory 1105 optionally may further be at least one storage apparatus located far away from the processor 1101. As shown in FIG. 11, the memory 1105 serving as a computer storage medium may include an operating system, a network communications module, a user interface module, and an online payment application program.

In the payment platform server 1100 shown in FIG. 11, the network interface 1104 is mainly used to connect a user terminal and perform data communication with the user terminal. The processor 1101 may be used to invoke the secured payment application program stored in the memory 1105 to execute the following operations:

Receiving, through the network interface 1104, order information sent by the user terminal, where the order information includes a payment account and a payment sum; Sending prompt information to the user terminal through the network interface 1104, where the prompt information is used for prompting input of verification information; Receiving, through the network interface 1104, verification information sent by the user terminal, where the verification information includes an identifier of the user terminal and fingerprint information input by a user in response to the prompt information; and verifying whether the fingerprint information and the identifier of the user terminal included in the verification information are the same as fingerprint information and an identifier of the user terminal that are recorded during registration of the user terminal respectively, and if same, performing a payment operation according to the order information.

In an example, the processor 1101 invokes the secured payment application program stored in the memory 1105 to further execute the following operations: before receiving, through the network interface 1104, order information sent by the user terminal, receiving, through the network interface 1104, a registration request sent by the user terminal, where the registration request includes an identifier of the user terminal; sending a notification message to the user terminal in response to the registration request through the network interface 1104, where the notification message is used for prompting input of fingerprint information; receiving, through the network interface 1104, fingerprint information sent by the user terminal, and storing (for example, storing to the memory 1105) the fingerprint information sent by the user terminal and the identifier of the user terminal included in the registration request; and sending, through the network interface 1104, a registration complete response to the user terminal.

In an example, the processor 1101 invokes the secured payment application program stored in the memory 1105 to further execute the following operations: after verifying that the fingerprint information and the identifier of the user terminal included in the verification information are the same as fingerprint information and an identifier of the user terminal that are recorded during registration of the user terminal respectively, and before performing a payment operation according to the order information, sending an order information confirmation request to the user terminal through the network interface 1104, where the order information confirmation request includes the payment account and the payment sum; and after receiving, through the network interface 1104, a confirmation response to the order information confirmation request and sent by the user terminal, executing the step of performing a payment operation according to the order information.

In an example, that the processor 1101 receives, through the network interface 1104, order information sent by the user terminal includes: receiving, by the processor 1101, through the network interface 1104, order information sent, through a transaction platform server, by a user terminal; and furthermore, the processor 1101 invokes the secured payment application program stored in the memory 1105 to further execute the following operations: receiving, through the network interface 1104, a discount rate that is sent by the transaction platform server and corresponds to a sum range where a historical payment sum of the user terminal belongs; and performing a payment discount operation according to the order information and the discount rate.

Therefore, by means of the payment platform server described in the example of FIG. 11, double security verification may be implemented according to fingerprint information and an identifier of a user terminal, and a payment operation is allowed after the double security verification, thereby enhancing security of payment. In addition, by means of the payment platform server described in FIG. 10, a complex operation resulting from that a user manually inputs a payment password may not be needed for the user terminal, so that a payment operation is simplified, and efficiency of online payment is enhanced.

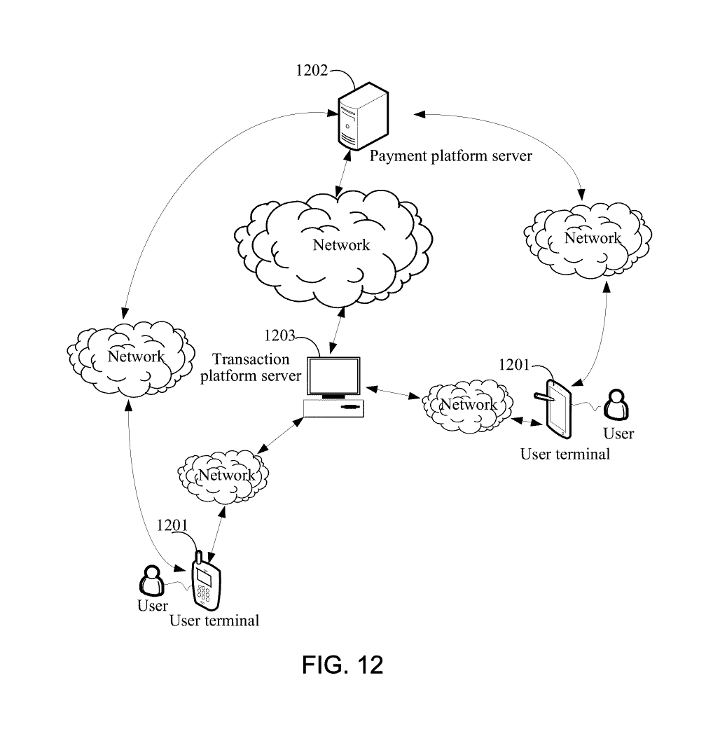

Referring to FIG. 12, FIG. 12 is a structural diagram of a secured payment system disclosed in an example of the present disclosure. As shown in FIG. 12, the secured payment system may include a user terminal 1201 and a payment platform server 1202, where the user terminal 1201 may be connected to the payment platform server 1202 through a network, where: the user terminal 1201 is used to send order information to the payment platform server 1202, where the order information includes a payment account and a payment sum; the payment platform server 1202 is used to receive the order information sent by the user terminal 1201, and send prompt information to the user terminal 1201, where the prompt information is used for prompting input of verification information; the user terminal 1201 is further used to receive the prompt information sent by the payment platform server 1202, and send verification information to the payment platform server 1202, where the verification information includes an identifier of the user terminal and fingerprint information input by a user in response to the prompt information.

The payment platform server 1202 is further used to receive the verification information sent by the user terminal 1201, and verify whether the fingerprint information and the identifier of the user terminal included in the verification information are the same as fingerprint information and an identifier of the user terminal that are recorded during registration of the user terminal 1201 respectively, and if same, perform a payment operation according to the order information.

In an example, the user terminal 1201 is further used to: before sending order information to the payment platform server 1202, send a registration request to the payment platform server 1202, where the registration request includes an identifier of the user terminal; correspondingly, the payment platform server 1202 is further used to send a notification message to the user terminal 1201 in response to the registration request, where the notification message is used for prompting input of fingerprint information.

Correspondingly, the user terminal 1201 is further used to receive a notification message sent by the payment platform server 1202, and send, to the payment platform server 1202, fingerprint information input by the user in response to the notification message; correspondingly, the payment platform server 1202 is further used to store the fingerprint information sent by the user terminal 1201 and the identifier of the user terminal included in the registration request.

Correspondingly, the payment platform server 1202 is further used to send a registration complete response to the user terminal 1201; and correspondingly, the user terminal 1201 is further used to receive the registration complete response sent by the payment platform server 1202.

In an example, the payment platform server 1202 is further used to: after verifying that the fingerprint information and the identifier of the user terminal included in the verification information are the same as fingerprint information and an identifier of the user terminal that are recorded during the registration of the user terminal 1201 respectively, and before performing a payment operation according to the order information, send an order information confirmation request to the user terminal 1201, where the order information confirmation request includes the payment account and the payment sum.

Correspondingly, the user terminal 1201 is further used to receive the order information confirmation request sent by the payment platform server 1202, and send, to the payment platform server 1202, a confirmation response to the order information confirmation request and input by the user; and correspondingly, the payment platform server 1202 is further used to: after receiving the confirmation response to the order information confirmation request and sent by the user terminal 1201, execute the step of performing a payment operation according to the order information.

In an example, the secured payment system shown in FIG. 12 further includes a transaction platform server 1203, where: the user terminal 1201 is used to send order information to the transaction platform server 1203; the transaction platform server 1203 is used to send the order information to the payment platform server 1202; the transaction platform server 1203 is further used to acquire a historical payment sum of the user terminal 1201, identify a sum range where the historical payment sum belongs, identify a discount rate corresponding to the sum range where the historical payment sum belongs, and send the discount rate to the payment platform server 1202.

Correspondingly, the payment platform server 1202 is further used to: after receiving the confirmation response to the order information confirmation request and sent by the user terminal 1201, perform a payment discount operation according to the order information and the discount rate.

In an example of the present disclosure, the transaction platform server 1203 is further used to: after sending the discount rate to the payment platform server 1202, update the historical payment sum according to the payment sum included in the order information.

Therefore, by means of the secured payment system described in the example in FIG. 12, double security verification may be implemented according to fingerprint information and an identifier of the user terminal, and a payment operation is allowed after the double security verification, thereby enhancing security of payment. In addition, by means of the secured payment system described in FIG. 12, a complex operation resulting from that a user manually inputs a payment password may not be necessary for the user terminal, so that a payment operation is simplified, and efficiency of online payment is enhanced.

A person of ordinary skill in the art may understand that all or a part of the steps of the method shown in FIG. 1 may be implemented by a program instructing relevant hardware of a user terminal. The program may be stored in a computer readable storage medium of the user terminal. The computer readable storage medium may be either transitory or non-transitory. The storage medium may include: a Universal Serial Bus (USB) flash drive, a read-only memory (ROM), a random access memory (RAM), a magnetic disk or an optical disc.

A person of ordinary skill in the art may understand that all or a part of the steps of the method shown in FIG. 4 may be implemented by a program instructing relevant hardware of a payment platform server. The program may be stored in a computer readable storage medium of the payment platform server. The storage medium may include: a USB flash drive, a ROM, a RAM, a magnetic disk or an optical disc.

The secured payment method and relevant device and system provided by the present disclosure are described above in detail. Although the principle and implementation manners of the present disclosure are described by using specific examples in this specification, descriptions of the examples are merely intended to help understand the methods and core idea of the present disclosure. Meanwhile, variations may be made to the specific implementation manner and application scope by persons of ordinary skill in the art according to the idea of the present disclosure. Therefore, the content of this specification shall not be construed as a limitation to the present disclosure.

What is claimed is:

1. A secured payment method, comprising:
sending, by a user terminal, order information to a payment platform server, wherein the order information comprises a payment account and a payment sum;
receiving, by the payment platform server, the order information sent by the user terminal, and sending prompt information to the user terminal, wherein the prompt information is used for prompting an input of verification information;
receiving, by the user terminal, the prompt information sent by the payment platform server, and sending verification information to the payment platform server, wherein the verification information comprises an identifier of the user terminal and fingerprint information input by the user terminal in response to the prompt information; and
receiving, by the payment platform server, the verification information sent by the user terminal, verifying whether the received fingerprint information and the received identifier of the user terminal match stored fingerprint information and a stored identifier of the user terminal that are stored during registration of the user terminal, and if yes, performing a payment operation according to the order information.

2. The method of claim 1, before the sending the order information to the payment platform server, further comprising:
sending, by the user terminal, a registration request to the payment platform server, wherein the registration request comprises the identifier of the user terminal;
sending, by the payment platform server, a notification message to the user terminal in response to the registration request, wherein the notification message is used for prompting the input of the fingerprint information;
receiving, by the user terminal, the notification message sent by the payment platform server, and sending, to the payment platform server, the fingerprint information input by the user terminal in response to the notification message;
storing, by the payment platform server, the fingerprint information sent by the user terminal and the identifier of the user terminal included in the registration request;
sending, by the payment platform server, a registration complete response to the user terminal; and
receiving, by the user terminal, the registration complete response sent by the payment platform server.

3. The method of claim 1, after the verifying the fingerprint information and the identifier of the user terminal and before the performing the payment operation according to the order information, further comprising:
sending, by the payment platform server, an order information confirmation request to the user terminal, wherein the order information confirmation request comprises the payment account and the payment sum;
receiving, by the user terminal, the order information confirmation request sent by the payment platform server, and sending, to the payment platform server, a confirmation response to the order information confirmation request input by the user terminal; and
after receiving, by the payment platform server, the confirmation response to the order information confirmation request and sent by the user terminal, performing the payment operation according to the order information.

4. The method of claim 3, wherein the sending the order information to the payment platform server comprises:
sending, by the user terminal, the order information to a transaction platform server; and
sending, by the transaction platform server, the order information to the payment platform server; and
after the sending, by the transaction platform server, the order information to the payment platform server,
acquiring, by the transaction platform server, a historical payment sum of the user terminal;
identifying, by the transaction platform server, a sum range where the historical payment sum belongs, and identifying a discount rate corresponding to the sum range where the historical payment sum belongs;
sending, by the transaction platform server, the discount rate to the payment platform server; and
after receiving the confirmation response to the order information confirmation request and sent by the user terminal, performing, by the payment platform server, a payment discount operation according to the order information and the discount rate.

5. The method of claim 4, after the sending the discount rate to the payment platform server, further comprising:
updating, by the transaction platform server, the historical payment sum according to the payment sum included in the order information.

6. A secured payment method, comprising:
receiving, by a payment platform server, order information sent by a user terminal, wherein the order information comprises a payment account and a payment sum;
sending, by the payment platform server, prompt information to the user terminal, wherein the prompt information is used for prompting an input of verification information;
receiving, by the payment platform server, verification information sent by the user terminal, wherein the verification information comprises an identifier of the user terminal and fingerprint information input by the user terminal in response to the prompt information; and
verifying, by the payment platform server, whether the received fingerprint information and the received identifier of the user terminal included in the verification information match stored fingerprint information and a stored identifier of the user terminal that are stored during registration of the user terminal, and if yes, performing a payment operation according to the order information.

7. The method of claim 6, before the receiving the order information sent by the user terminal, further comprising:
receiving, by the payment platform server, a registration request sent by the user terminal, wherein the registration request comprises the identifier of the user terminal;
sending, by the payment platform server, a notification message to the user terminal in response to the registration request, wherein the notification message is used for prompting the input of the fingerprint information;
receiving, by the payment platform server, the fingerprint information sent by the user terminal, and storing the fingerprint information sent by the user terminal and the identifier of the user terminal included in the registration request; and
sending, by the payment platform server, a registration complete response to the user terminal.

8. The method of claim 6, after the verifying the fingerprint information and the identifier of the user terminal and before the performing the payment operation according to the order information, further comprising:
sending, by the payment platform server, an order information confirmation request to the user terminal, wherein the order information confirmation request comprises the payment account and the payment sum; and
after receiving a confirmation response to the order information confirmation request sent by the user terminal, performing, by the payment platform server, the payment operation according to the order information.

9. The method of claim 8, wherein the receiving the order information sent by the user terminal comprises:
receiving, by the payment platform server, the order information, sent through a transaction platform server, by the user terminal;
receiving, by the payment platform server, a discount rate that is sent by the transaction platform server and corresponds to a sum range where a historical payment sum of the user terminal belongs; and
performing, by the payment platform server, a payment discount operation according to the order information and the discount rate.

10. A payment platform server, comprising:
a receiving unit, used to receive order information sent by a user terminal, wherein the order information comprises a payment account and a payment sum;
a sending unit, used to send prompt information to the user terminal, wherein the prompt information is used for prompting an input of verification information;
wherein the receiving unit is further used to receive the verification information sent by the user terminal, wherein the verification information comprises an identifier of the user terminal and fingerprint information input by the user terminal in response to the prompt information;
a verification unit, used to verify whether the received fingerprint information and the received identifier of the user terminal included in the verification information match stored fingerprint information and a stored identifier of the user terminal that are stored during registration of the user terminal; and
an operation unit, used to:
when a verification result of the verification unit is yes, perform a payment operation according to the order information.

11. The payment platform server of claim 10, wherein:
the receiving unit is further used to:
before receiving the order information sent by the user terminal, receive a registration request sent by the user terminal, wherein the registration request comprises the identifier of the user terminal;
the sending unit is further used to:
send a notification message to the user terminal in response to the registration request, wherein the notification message is used for prompting the input of the fingerprint information;
the receiving unit is further used to:
receive the fingerprint information sent by the user terminal;
the payment platform server further comprises:
a storage unit, used to store the fingerprint information sent by the user terminal and the identifier of the user terminal included in the registration request; and
the sending unit is further used to:
send a registration complete response to the user terminal.

12. The payment platform server of claim 10, wherein:
the sending unit is further used to:
after the verification unit verifies the fingerprint information and the identifier of the user terminal included in the verification information, send an order information confirmation request to the user terminal, wherein the order information confirmation request comprises the payment account and the payment sum; and
the receiving unit is further used to:
after receiving a confirmation response to the order information confirmation request and sent by the user terminal, trigger the operation unit to perform the payment operation according to the order information.

13. The payment platform server of claim 12, wherein:
the receiving unit is used to receive the order information, sent through a transaction platform server, by the user terminal;
the receiving unit is further used to receive a discount rate that is sent by the transaction platform server and corresponds to a sum range where a historical payment sum of the user terminal belongs; and
the operation unit is further used to perform a payment discount operation according to the order information and the discount rate.

14. A secured payment system, comprising a user terminal and a payment platform server, wherein:
the user terminal is used to send order information to the payment platform server, wherein the order information comprises a payment account and a payment sum;
the payment platform server is used to receive the order information sent by the user terminal, and send prompt information to the user terminal, wherein the prompt information is used for prompting an input of verification information;
the user terminal is further used to receive the prompt information sent by the payment platform server, and send verification information to the payment platform server, wherein the verification information comprises an identifier of the user terminal and fingerprint information input by the user terminal in response to the prompt information; and
the payment platform server is further used to receive the verification information sent by the user terminal, verify whether the received fingerprint information and the received identifier of the user terminal included in the verification information match stored fingerprint information and a stored identifier of the user terminal that are stored during registration of the user terminal, and if yes, perform a payment operation according to the order information.

15. The system of claim 14, wherein, the user terminal is further used to:
before sending the order information to the payment platform server, send a registration request to the payment platform server, wherein the registration request comprises the identifier of the user terminal;
the payment platform server is further used to send a notification message to the user terminal in response to the registration request, wherein the notification message is used for prompting the input of the fingerprint information;
the user terminal is further used to receive the notification message sent by the payment platform server, and send, to the payment platform server, the fingerprint information input by the user terminal in response to the notification message;
the payment platform server is further used to store the fingerprint information sent by the user terminal and the identifier of the user terminal included in the registration request;
the payment platform server is further used to send a registration complete response to the user terminal; and
the user terminal is further used to receive the registration complete response sent by the payment platform server.

16. The system of claim 14, wherein:
the payment platform server is further used to:
after verifying the fingerprint information and the identifier of the user terminal, and before performing the payment operation according to the order information, send an order information confirmation request to the user terminal, wherein the order information confirmation request comprises the payment account and the payment sum;
the user terminal is further used to:
receive the order information confirmation request sent by the payment platform server, and send, to the payment platform server, a confirmation response to the order information confirmation request and input by the user terminal; and
the payment platform server is further used to:
after receiving the confirmation response to the order information confirmation request and sent by the user terminal, perform the payment operation according to the order information.

17. The system of claim 16, further comprising a transaction platform server, wherein:
the user terminal is used to:
send order information to the transaction platform server;
the transaction platform server is used to:
send the order information to the payment platform server;
the transaction platform server is further used to:
after sending the order information to the payment platform server, acquire a historical payment sum of the user terminal, identify a sum range where the historical payment sum belongs, identify a discount rate corresponding to the sum range where the historical payment sum belongs, and send the discount rate to the payment platform server; and
the payment platform server is further used to:
after receiving the confirmation response to the order information confirmation request and sent by the user terminal, perform a payment discount operation according to the order information and the discount rate.

18. The system of claim 17, wherein the transaction platform server is further used to:
after sending the discount rate to the payment platform server, update the historical payment sum according to the payment sum included in the order information.
